(19) United States
(12) Patent Application Publication
(10) Pub. No.: US 2020/0086707 A1
(43) Pub. Date: Mar. 19, 2020

(54) SPRING SUPPORT CONFIGURED TO RECEIVE A COIL SPRING OF A MOTOR-VEHICLE SPRING SYSTEM, MOTOR-VEHICLE SPRING SYSTEM, AND USE OF A SPRING SUPPORT

(71) Applicant: BASF SE, Ludwigshafen am Rhein (DE)

(72) Inventors: Waldemar MEIER, Lemfoerde (DE); Kai BUSCHEMOEHLE, Lemfoerde (DE)

(73) Assignee: BASF SE, Ludwigshafen am Rhein (DE)

(21) Appl. No.: 16/500,677

(22) PCT Filed: Apr. 6, 2018
(86) PCT No.: PCT/EP2018/058938

§ 371 Date: Oct. 3, 2019

(30) Foreign Application Priority Data
Apr. 6, 2017 (EP) 17165321.5

(51) Int. Cl. B60G 11/16; F16F 1/12

(52) U.S. Cl. CPC B60G 11/16; B60G 2206/73; B60G 2204/12422; F16F 1/126

(57) ABSTRACT

The invention relates to a spring support (1, 1′, 1″) configured to receive a coil spring (50) of a motor-vehicle spring system (100), where the coil spring (50) has a length in the direction of a longitudinal axis (L) that is variable between a state of minimal compression and a state of maximal compression, and said coil spring comprises a terminal coil section (51) that rests on an annular surface of the spring support (1, 1″). An elastically deformable projecting element (18) is arranged between the annular surface of the spring support and the coil spring, and is configured to maintain contact with the terminal coil section (51) of the coil spring (50) during both maximal and minimal compression of the coil spring (50).

The present invention relates to a spring support configured to receive a coil spring of a motor-vehicle spring system, wherein the coil spring has a length in the direction of a longitudinal axis that is variable between a state of minimal compression and a state of maximal compression, and said coil spring comprises a terminal coil section rests on an annular surface of the spring support.

Spring supports of the type described above are well known in the prior art, and are used to hold the coil spring of a motor-vehicle spring system. The spring supports are usually mounted in holders which in turn are connected to the bodywork and, respectively, to the wheel suspension system. Dependable functioning and durability of the coil spring in a motor-vehicle spring system is extremely important for vehicle safety. The durability of coil springs is usually increased by providing these with a coating that prevents corrosion, and that also prevents ingress of moisture, acid, etc. During the operation of motor vehicles, particles and moisture are inevitably swirled up and come into contact with the coil spring of the vehicle spring system. During operation of the vehicle, the coil spring is extended and compressed, and in the case of conventional motor-vehicle spring systems this leads to a variable gap between the terminal coil section and the spring support. Particles and moisture penetrating into this variable gap cause friction which damages the coating of the coil spring. The long-term effect of this is that the coating fails, with resultant corrosion and cracking, and in the worst case breakage of the spring. This is to be avoided as much as possible.

DE 10 2007 050084 A1 describes a spring support comprising an annular surface divided into a first circumferential section and a second circumferential section, wherein the first circumferential section is configured to receive the first coil section, and the second circumferential section is configured to receive the second coil section of the coil spring. The entire annular surface of the spring support is therefore in contact with the coil spring at least while the vehicle spring system is loaded with the weight of the unoccupied vehicle, also referred to as with curb weight, which could be said to represent the normal condition. However, the structure proposed in DE 10 2007 050084 A1 cannot prevent formation of a gap between the coil spring and the spring support when high degrees of extension and compression are experienced, and said structure does not therefore eliminate the problem of ingress of moisture and particles.

Accordingly, it was an object of the invention to improve a spring support of the type described above in a manner that further increases the durability of the coil spring. In particular, it was an object of the invention to achieve a further reduction with the risk of ingress of dirt and moisture.

The invention achieves said object in that an elastically deformable projecting element is arranged between the coil spring and the annular surface of the spring support and configured to maintain contact with the terminal coil section of the coil spring during both maximal and minimal compression of the coil spring. In particular, surface the elastically deformable projecting element is configured to be more resilient, i.e. amenable to greater deformation in the direction of the longitudinal axis of the coil spring in comparison with the annular surface of the spring support. The invention is based on the discovery that, through selection of a more resilient projecting element, in comparison with the other constituents of the spring support in the direction of the longitudinal axis, it is possible to place a flexible wedge between spring support and coil spring in a manner such that changes in dimensions of the elastically deformable projecting element cover the entire amplitude of movement between minimal and maximal compression of the coil spring. To this end, it is particularly preferable that, even when compression of the coil spring is minimal, the elastically deformable projecting element is still subject to elastic deformation, i.e. is in compression between the coil spring and the spring support. Lifting of the coil spring away from the spring support is thus avoided, and formation of an undesirable gap is prevented.

In a preferred embodiment of the invention, the spring support comprises a main body composed at least partially, i.e. partially or entirely, of a hard component preferably selected from a list consisting of:
thermoplastic polyurethane (TPU);
polypropylene (PP);
polyoxymethylene (POM);
polycarbonate (PC); and
polyamide (PA).

In another preferred embodiment, the elastically deformable projecting element comprises a spring element made of a soft component. The meaning of the expression “soft component” is in particular that, in comparison with the hard component, the stiffness of the soft component is lower, and the ability thereof to undergo elastic change of shape is greater. The spring element preferably consists to some extent or entirely of a volume-compressible material. It is particularly preferable that the volume-compressible material takes the form of elastomer based on cellular, in particular microcellular, polyisocyanate-polyaddition products, in particular based on microcellular polyurethane elastomers and/or on thermoplastic polyurethane, preferably comprising polyurea structures.

Volume-compressible materials such as the abovementioned have the particular advantage that, in comparison with other materials such as rubber, they have extremely high capability for elastic change of shape, together with high durability.

The polyisocyanate-polyaddition products are preferably based on microcellular polyurethane elastomers, based on thermoplastic polyurethane, or composed of combinations of these two materials, where these can optionally comprise polyurea structures.

Particular preference is given to microcellular polyurethane elastomers which, in a preferred embodiment, have a density in accordance with DIN 53420 of from 200 kg/m³ to 1100 kg/m³, preferably from 300 kg/m³ to 800 kg/m³, a tensile strength in accordance with DIN 53571 of 2 N/mm², preferably from 2 N/mm² to 8 N/mm², an elongation in accordance with DIN 53571 of 300%, preferably from 300% to 700% and a resistance to tear propagation in accordance with DIN 53515 that is preferably from 8 N/mm to 25 N/mm.

It is preferable that the elastomers are microcellular elastomers based on polyisocyanatepolyaddition products, preferably with cells with diameter from 0.01 mm to 0.5 mm, particularly from 0.01 to 0.15 mm.

Elastomers based on polyisocyanate-polyaddition products and production thereof are well known and widely described, for example in EP-A 62 835, EP-A 36 994, EP-A 250 969, DE-A 195 48 770 and DE-A 195 48 771.

They are usually produced via a reaction of isocyanates with compounds reactive toward isocyanates.

The elastomers based on cellular polyisocyanate-polyaddition products are usually produced in a mold in which the reactive starting components are reacted with one another. Molds used here can be molds that are in general use, an example being metal molds which by virtue of their shape ensure that the spring element has the three-dimensional shape of the invention. In one embodiment, a foaming mold is used to produce the shaped elements. In another embodiment, they are incorporated subsequently into the concentric main body. It is also possible to use parts manufactured from semifinished products. The manufacturing process can by way of example use water-jet cutting.

The polyisocyanate-polyaddition products can be produced by well-known processes, for example by using the following starting materials in a one- or two-stage process:
(a) isocyanate,
(b) compounds reactive toward isocyanates,
(c) water and optionally
(d) catalysts,
(e) blowing agents and/or
(f) auxiliaries and/or additives, for example polysiloxanes and/or fatty acid sulfonates.

The surface temperature of the internal wall of the mold is usually from 40° C. to 95° C., preferably from 50° C. to 90° C. The NCO/OH ratio used for the production of the moldings is advantageously from 0.85 to 1.20, and the heated starting components here are mixed and introduced in a quantity corresponding to the desired density of the molding into a heated mold, which can preferably be closed in a manner that prevents leakage. After from 5 minutes to 60 minutes, the moldings have hardened and can therefore be demolded. The quantity of the reaction mixture introduced into the mold is usually such that the resultant moldings have the density described above. The temperature at which the starting components are introduced into the mold is usually from 15° C. to 120° C., preferably from 30° C. to 110° C. The degree of compaction used to produce the moldings is from 1.1 to 8, preferably from 2 to 6. The cellular polyisocyanate-polyaddition products are advantageously produced by the one-shot process, using high-pressure technology, low-pressure technology, or in particular reaction injection molding technology (RIM), in open or preferably closed molds. Alternatively, a prepolymer process is used to produce the cellular polyisocyanatepolyaddition products. The reaction is in particular carried out with compaction in a closed mold. Reaction injection molding technology is described by way of example by H. Piechota and H. Röhr in “Integralschaumstoffe” [Integral foams], Carl Hanser-Verlag, Munich, Vienna, 1975; D. J. PrepeIke and J. L. Wharton in Journal of Cellular Plastics, March/April 1975, pp. 87 to 98 and U. Knipp in Journal of Cellular Plastics, March/April 1973, pp. 76-84.

In a preferred embodiment, the elastically deformable projecting element and the main body are connected by way of friction form fit, or material joining. In the case of suitable combinations of materials, for example TPU as hard component and microcellular polyurethane elastomer as soft component, material joining can be achieved advantageously by means of injection molding, or sometimes by means of multicomponent injection molding. Other combinations of materials can be connected to one another by way of example advantageously by means of adhesive bonding. Alternatively or in addition, the elastically deformable projecting element, or at least its spring element, and the main body are connected frictionally or form-fittingly by means of suitable lock-fit connections.

In another preferred embodiment, the spring element is a ring segment and comprises a material thickness that is constant or increases in circumferential direction. The increase in circumferential direction by way of example gives the spring element a wedge shape that can be placed between the spring support and the coil spring and provides good performance in terms of intimate contact, with low assembly cost.

It is particularly preferable to position the spring element so that when a coil spring is in place, said spring element is in direct contact with the coil spring, and preferably nestles up against the coil spring. The expression “nestling up” here means that a substantial surface of the spring element is in contact with the coil spring, where the spring element extends around a portion of the circumference of the coil section of the coil spring. Greater compression of the spring element causes nestling.

In another preferred embodiment, an alternative provides that the elastically deformable projecting element comprises a support ring segment pivotably to the main body and positioned between the coil spring and the spring element, when a coil spring is in place. In this embodiment, therefore, the spring element is not arranged in direct contact with the coil spring, but instead is separated from the coil spring by the support ring segment. The shape of the support ring segment is preferably such that, when a coil spring is in place, said segment nestles up against the coil spring.

It is particularly preferable that the support ring segment and the main body of the spring support consist of the same hard component.

It is further preferable that the support ring segment is integrally formed with the main body by means of a film hinge.

In another preferred embodiment, the elastically deformable projecting element comprises a spring element in the form of one or more helical compression springs. The use of one or more helical compression springs instead of or in addition to an elastically deformable soft component is particularly preferred in embodiments which also employ the elastically deformable projecting element to comprise a supportive ring segment connected in a pivotably articulative manner to the main body as described hereinabove.

In another preferred embodiment of the spring support, the main body comprises a recess into which the spring element is inserted. The recess is configured to define the positioning of the spring element on the spring support. The recess ensures that under compression the spring element does not deviate from its intended radial position. The recess can be level, with a recess floor extending substantially parallel to the annular surface of the spring support, or in an alternative preferred embodiment it can have a pitch relative to the annular surface. A recess substantially parallel to the annular surface is adapted for use with a spring element comprising an increasing material thickness in circumferential direction, whereas a recess with a pitch relative to the annular surface is adapted for use of a spring element having constant material thickness in circumferential direction. Other combinations of recess and spring-element geometry are always also conceivable, as required by pitch-to-diameter ratio of the coil spring.

In a particularly preferred embodiment the recess comprises a drainage aperture. The drainage aperture allows liquid located on the spring support to escape downward away from the coil spring. Moisture which is displaced as a consequence of compression of the spring element is likewise advantageously directly discharged downward away from the coil spring through the drainage aperture.

In another advantageous embodiment, the spring support comprises a lateral guide on the radial periphery that extends from the annular surface in the direction of the coil spring and ensures that the elastically deformable projecting element cannot deviate from its intended radial position. The lateral guide moreover increases the stability of the spring support. It is preferable that the lateral guide is integrally formed with the main body of the spring support, and the lateral guide and the main body consist of the same hard component.

In another preferred embodiment, the spring support comprises a plurality of draining recesses provided in the annular surface of the main body. Preferably, the draining recesses extend radially outwards across the annular surface. The draining recesses in the annular surface contribute to keeping liquid and dirt particles away from the terminal section of the coil spring during operation of the spring system without adverse effects on the stability of the spring support.

The invention has been described above with reference to the spring support. However, another aspect of the invention provides a motor-vehicle spring system having a coil spring and at least one spring support which holds the coil spring, wherein the coil spring has a length in the direction of a longitudinal axis that is variable between a state of minimal compression and a state of maximal compression, and said coil spring comprises a terminal coil section that rests an annular surface of the spring support.

The invention achieves the object described above in this motor-vehicle spring system, in that the spring support is configured according to any one of the preferred embodiments described above. The motor-vehicle spring system of the invention and the spring support of the invention therefore utilize the same advantages and the same embodiments, and in this connection reference is made therefore to the above statements.

In another aspect of the invention a use of an elastically deformable projecting element in a spring support intended to receive a coil spring of a motor-vehicle spring system is suggested, in particular in a spring support according to any of the preferred embodiments described above.

The invention achieves the object in this use by having the coil spring comprising a length in the direction of a longitudinal axis that is variable between a state of minimal compression and a state of maximal compression, and said coil spring comprising a terminal coil section that rests on an annular surface of the spring support, wherein the elastically deformable projecting element is arranged between the annular surface of the spring support and the coil spring, and is configured to maintain contact with the terminal coil section of the coil spring during both maximal and minimal compression of the coil spring.

The inventive use and the spring support described above, and the motor-vehicle spring system described above, incorporate the same advantages and the same preferred embodiments, and again therefore reference is made in this connection to the explanations provided above.

The invention is explained in more detail under reference to preferred embodiments as well as the enclosed figures. Herein:

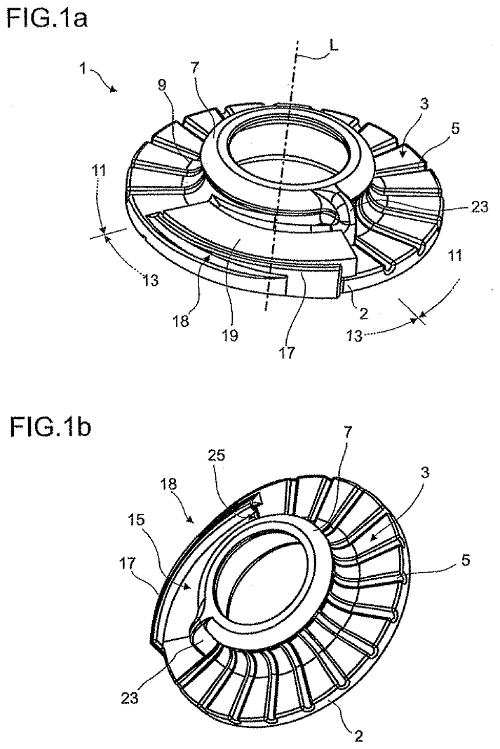

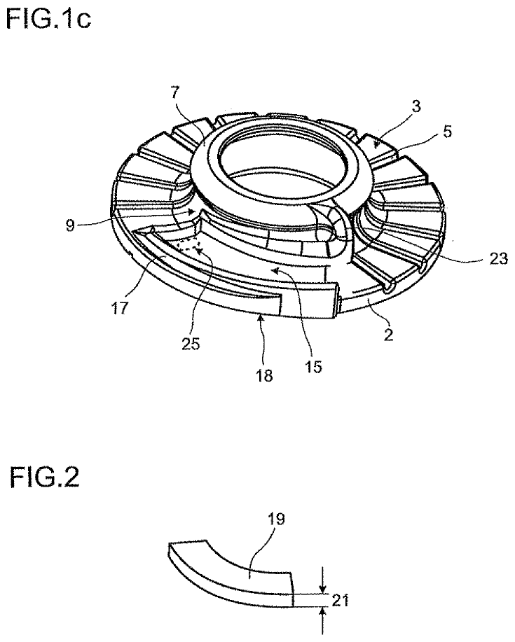

FIGS. 1a-c show various three-dimensional views of a first embodiment of a spring support,

FIG. 2 shows an example of a spring element for the spring support of FIGS. 1a-c,

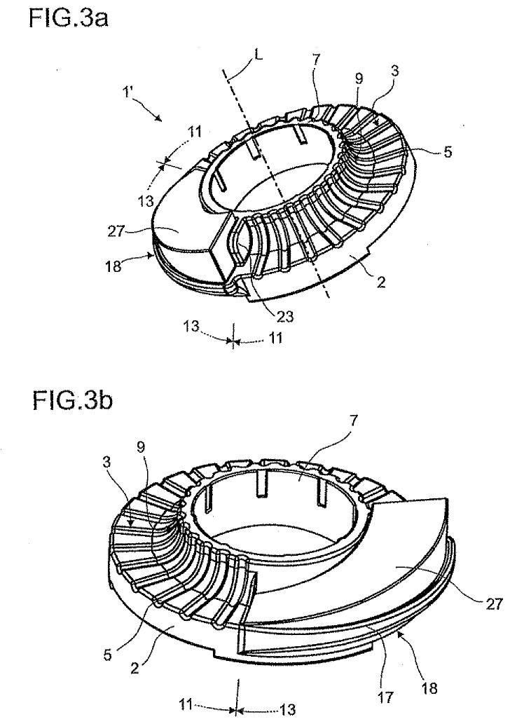

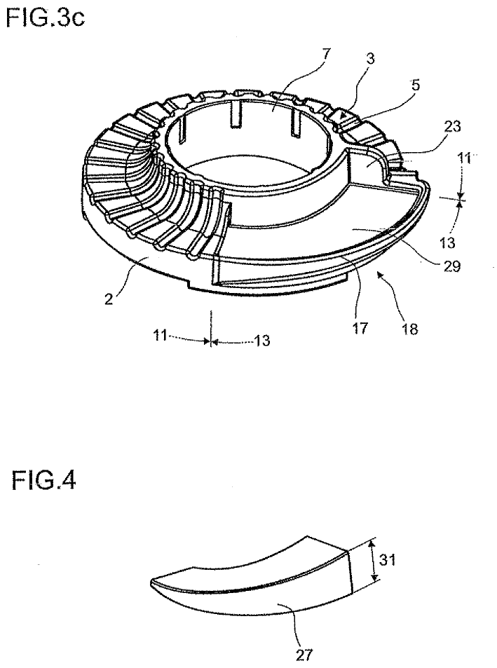

FIGS. 3a-c show various three-dimensional views of a second embodiment of a spring support,

FIG. 4 shows an example of a spring element for the spring support of FIGS. 1a-c or 3a-c,

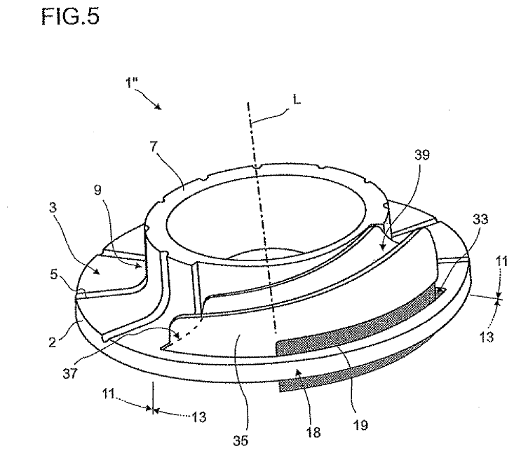

FIG. 5 shows a three-dimensional depiction of a third preferred embodiment of a spring support, and

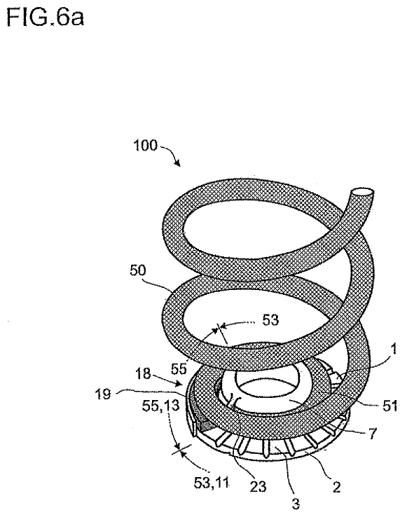

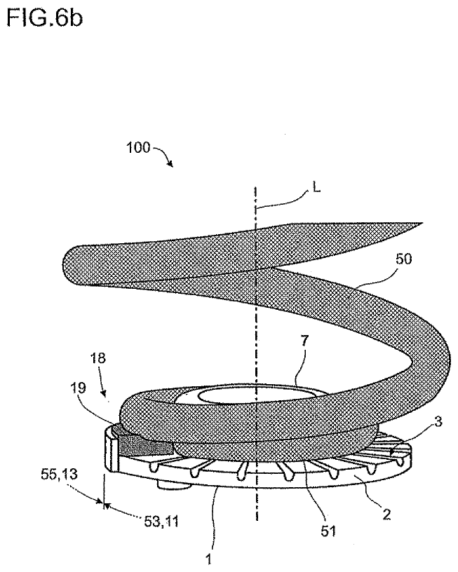

FIGS. 6a-b show various three-dimensional views of a preferred embodiment of a motor-vehicle spring system.

FIGS. 1a-c show a first embodiment of a spring support 1 of the invention. The spring support comprises a main body 2 with an annular surface 3. The annular surface 3 comprises a plurality of recesses 5 provided for draining purposes in the annular surface 3. At the radially inner margin of the annular surface 3, there is a sleeve 7 extending in the direction of a longitudinal axis L. Provided on the sleeve 7 is an external profile 9 intended to receive a correspondingly shaped terminal coil section 51 of a coil spring 50 (cf. FIGS. 6a, b). The draining recesses 5 extend radially outwards from sleeve 7 across the annular surface 3 against which the terminal coil section 51 is supposed to rest.

The following is to be understood relating to the coil spring and to the circumferential sections described below. It could also be possible that, received on the annular surface 3 in the same fashion, there is a coil spring which does not comprise a coil section running perpendicularly to the longitudinal axis L, but instead comprises only an end face running perpendicularly to the longitudinal axis of the coil spring. It would likewise be possible that, received on the annular surface 3, there is a coil spring which comprises no face element at all running perpendicularly to its longitudinal axis L, but instead by way of example is, as far as the end of its terminal coil section, purely helical. In the last-mentioned case, the “coil section” and the corresponding “circumferential section” would respectively be reduced to a point or a line. In all cases, however, the coil spring would be in contact, even if only point contact, with the annular surface 3 of the coil spring. The invention is not restricted to this embodiment of division of the annular surface into circumferential sections or to the use of a particular type of coil spring.

The annular surface 3 is divided into a first circumferential section 11 and a second circumferential section 13. The first circumferential section 11 is intended to receive a contact surface of the coil spring in a first coil section. In turn, the second circumferential section 13 is configured to receive a second coil-spring section which proceeds away from the contact surface at an angle.

In the second circumferential section 13 there is a recess 15 provided which is configured to receive an elastically deformable projecting element 18. The recess 15 has a pitch relative to the annular surface 3 of the first circumferential section 11. At a radially external location adjacent to the recess 15, and in circumferential direction adjacent to the first circumferential section 11, the spring support 1 comprises a lateral guide 17 which is configured to prevent radial outward displacement of the elastically deformable projecting element 18 away from its intended position.

The elastically deformable projecting element 18 comprises a spring element 19, preferably composed of a soft component, particularly preferably of a volume-compressible material as in one of the preferred embodiments described above. By virtue of the volume-compressibility of the spring element 19, the entirety of the second coil section 55 of a coil spring 50 can nestle up against the spring element 19 in a manner such that no gap arises between the spring support 1 and the coil spring (cf. FIGS. 6a, b).

On the sleeve 7, there is, above the annular surface 3 on the spring support 21, a projecting element 23 which in essence extends radially outward and serves as stop for the first coil section of the terminal coil section of a coil spring.

The recess 15 comprises a drainage aperture 25 configured to conduct liquid out of the spring support 1, away from the coil spring.

FIG. 2 exemplarily depicts the spring element 19 from the embodiment shown in FIGS. 1a-c. The spring element (19) is configured as ring segment and comprises material of constant thickness 21 in circumferential direction.

FIGS. 3a-c show a spring support 1′ of a second embodiment of the invention. Significant constituents of the spring support 1′ are the same as those of the spring support 1 in FIGS. 1a-c. In respect of identical reference signs, reference is made to the descriptions above.

The spring support 1′ differs from the spring support 1 in figures la-c in that the former comprises, in the second circumferential section 13, a recess 29 that exhibits no pitch relative to the annular surface 3 in the first circumferential section 11, but instead is oriented substantially parallel to the annular surface 3. Arranged in the recess 29 there is a spring element 27, which is configured as ring segment, but differs from the spring element 19 in FIG. 2 in that it comprises an increasing material thickness 31 in circumferential direction. The invention provides the use of the spring element 19 in place of the spring element 27, and equally provides a design of the recess 29 with a pitch as in FIGS. 1a-c.

The spring supports 1 and 1′ in FIGS. 1a-3c were characterized in that the spring element 19, 27 of the elastically deformable projecting element 18 is intended for direct contact with the coil spring 50. The third embodiment of the invention, depicted in FIG. 5, differs therefrom. FIG. 5 shows a spring support 1″. Significant constituents of the spring support 1″ have the same function as those of the spring support in FIGS. 1a-c and 3a-c. Identical reference signs relate to identical elements, and here again therefore reference is made in this connection to the descriptions above. The elastically deformable projecting element 18 in the spring support 1″ differs from that in the spring supports 1 and 1′ in the above figures in that it comprises a supportive ring segment 35 joined to the spring support 1″ by means of a film hinge 37. It is preferable that the supportive ring segment 35 and the main body 2 of the spring support 1″ are composed of the same hard component.

The support ring segment 35 can be pivoted by means of the film hinge 37 in order to follow the compressive motion of the coil spring at all times. The restoring force is applied by the spring element 19, which is placed below the support ring segment 35 and positioned in a cutout 33 provided within the second circumferential section 13.

The support ring segment 35 has a concave profile 39 which corresponds to the cross section of the coil-spring section and is configured to nestle up against the coil spring.

FIGS. 1a-5 have shown various embodiments of the actual spring supports 1, 1 and 1″, and FIGS. 6a, b are now directed to illustration of the mode of action of the spring supports as they interact with a coil spring 50 in a motor-vehicle spring system 100. The terminal coil section 51 of the coil spring 50 in the motor-vehicle spring system 100 has been received by the spring support 1. It would of course also be possible in the invention to provide one of the other spring supports 1′, 1″ in place of the spring support 1, which corresponds to the embodiment of FIGS. 1a-c. The elements shown in the figures with respect to spring supports 1 and 1′ are to be understood as optional features of spring support 1″, as well.

A first coil section 53 of the terminal coil section 51 is in contact with the annular surface 3 of the spring support t In a second coil section 55, the terminal coil section 51 extends, at its particular angle, away from the annular surface 3 of the spring support 1. Between the terminal coil section 51 and the annular surface 3 of the spring support 1, the invention provides an elastically deformable projecting element 18 with a spring element 19, this spring element 19 nestling up against the coil spring 50. Whereas the main body 2 of the spring support 1 consists of a hard component and substantially undeformable, at least when subjected to the forces exerted by the coil spring 50, the spring element 19 is concurrently compressed whenever the coil spring 50 is compressed, and thus can provide constant contact with the coil spring 50 in a manner that prevents entry of any particles or substantial quantities of liquid between spring support 1 and coil spring 50 in the region of the terminal coil section 51. This provides reliable avoidance of abrasive damage to the coating of the coil spring 50.

1-15. (canceled)

16. A spring support, which is configured to receive a coil spring of a motor-vehicle spring system, wherein the coil spring has a length in a direction of a longitudinal axis 04 that is variable between a state of minimal compression and a state of maximal compression, and wherein the coil spring comprises a terminal coil section that rests on an annular surface of the spring support,
wherein an elastically deformable projecting element is arranged between the annular surface of the spring support and the coil spring, and is configured to maintain contact with the terminal coil section of the coil spring during both maximal and minimal compression of the coil spring; and
wherein the elastically deformable projecting element comprises a support ring segment pivotably connected to a main body and positioned between the coil spring and a spring element when the coil spring is in place.

17. The spring support of claim 16, wherein the spring support comprises a main body composed partially or entirely of a hard component.

18. The spring support of claim 16, wherein the elastically deformable projecting element comprises a spring element made of a soft component.

19. The spring support of claim 17, wherein the elastically deformable projecting element and the main body are connected by friction, form tit or material joining.

20. The spring support of claim 18, wherein the spring element is a ring segment, and has a constant material thickness or an increasing material thickness in a circumferential direction.

21. The spring support of claim 18, wherein the spring element is positioned such that when the coil spring is in place, the spring element directly contacts the coil spring.

22. The spring support of claim 16, wherein the support ring segment and the main body are composed of the same hard component.

23. The spring support of claim 16, wherein the support ring segment and the main body are integrally formed with a film hinge.

24. The spring support of claim 16, wherein the spring element is in the form of one or more helical compression springs.

25. The spring support of claim 17, wherein the main body comprises a recess into which the spring element is inserted.

26. The spring support of claim 25, wherein the recess has a pitch relative to the annular surface.

27. The spring support of claim 25, wherein the recess comprises a drainage aperture.

28. The spring support of claim 16. wherein the spring support comprises a lateral guide on its radial periphery that extends from the annular surface in the direction of the coil spring and is configured to keep the elastically deformable projecting element from deviating from its intended radial position.

29. A motor-vehicle spring system comprising a coil spring and at least one spring support which holds the coil spring, wherein the coil spring has a length in a direction of a longitudinal axis (L) that is variable between a state of minimal compression and a state of maximal compression, and the coil spring comprises a terminal coil section that rests on an annular surface of the at least one spring support, wherein the at least one spring support comprises the spring support of claim 16.

30. The spring support of claim 17, wherein the hard component is selected from the group consisting of a thermoplastic polyurethane (TPU), a polypropylene (PP), a polyoxymethylene (POM), a polycarbonate (PC), and a polyamide (PA).

31. The spring support of claim 18, wherein the soft component is a volume-compressible material.

32. The spring support of claim 31, wherein the volume-compressible material is an elastomer based on a cellular or microcellular polyisocyanate-polyaddition product.

33. The spring support of claim 32, wherein the cellular or microcellular polyisocyanate-polyaddition product is based on a microcellular polyurethane elastomer and/or a thermoplastic polyurethane.

34. The spring support of claim 33, wherein the microcellular polyurethane elastomer and the thermoplastic polyurethane comprise polyurea structures.

35. The spring support of claim 21, wherein the spring element nestles up against the coil spring.
